(19) United States
(12) Patent Application Publication
(10) Pub. No.: US 2005/0052437 A1
(43) Pub. Date: Mar. 10, 2005

(54) Temperature sensor circuit for microdisplays

(75) Inventor: Edwin Lyle Hudson, Los Altos, CA (US)

Correspondence Address: Bo-In Lin, 13445 Mandoli Drive, Los Altos Hills, CA, 94022, US

(73) Assignee: eLCOS Microdisplay Technology, Inc.

(21) Appl. No.: 10/627,230

(22) Filed: Jul. 24, 2003

Related U.S. Application Data
(60) Provisional application No. 60/403,686, filed on Aug. 14, 2002.

(51) Int. Cl. G09G 5/00

(52) U.S. Cl. 345/204

(57) ABSTRACT

This invention discloses a proportional to absolute temperature (PTAT) type of temperature measurement to improve the accuracy of temperature measurements. Instead of measuring resistance variations across a distance of diode, a technique of temperature determination using frequency measurements is performed in this invention through a voltage control oscillator. The measurement circuits are more compatible with the use of a flexible PCA connection to the microdisplay to a board. The basic circuit of this invention achieved an improved resistance noise and provides additional operation modes with added benefits of more conveniently and flexibly determining an operation mode to overcome the measurement noises. Furthermore, measurement of frequency as carried out by this invention improves the measurement accuracy and reduces the likelihood of false temperature readings.

This Application is a Continuation-in-Part (CIP) Application and claim a Priority Date of Aug. 14, 2002 benefited from a Provisional Patent Application 60/403,686 file by one common inventor of this Patent Application.

### BACKGROUND OF THE INVENTION

1. Field of the Invention

The present invention pertains to liquid crystal on silicon (LCOS) displays, and more particularly to improved temperature sensor design and configuration for liquid crystal on silicon displays with more accurate and direct temperature measurements to achieve better image display.

2. Description of the Prior Art

Since microdislay systems, especially the liquid crystal on silicon (LCOS) Microdisplay frequently operate in the hot interior of a projection device, the microdisplay technology is still challenged by the need to accurately measure the temperature and to control the temperature within appropriate range such that the quality of display would not be impaired by uncontrolled high temperatures. Specifically, the effectiveness of a conventional temperature sensor that uses a diode as a variable resistor is limited by a system architecture that requires the system resistance from a distance. Such measurements usually do not provide sufficient accuracy for the microdisplay systems, particularly as all components within such the Microdisplay devices have performance characteristics that are temperature dependent. A first sensitivity of LCOS microdisplays is the reduction of the birefringence of the liquid crystal material with elevated temperature within such a display with thus the electro-optic (EO) curve for such a device is highly temperature dependent. One particular aspect of this temperature driven effect is that the dark state rises as temperature deviates from the design temperature and therefore the contrast of such a system suffers. Even though the system electrical and mechanical designs can take these vulnerabilities into account by providing compensating mechanisms, but that requires use of a sensor that can accurate measure the temperature state of the liquid crystal in order for such system to function effectively.

FIG. 1 shows the strong influence of the temperature changes on the electro-optic performance of a nematic liquid crystal cell constructed by using a 45° twisted nematic (45° TN) in normally black (NB) electro-optic mode. The cell is nominally 5.5 μm thick. The clearing temperature of the liquid crystal is not precisely known but is estimated to be 85° C. Four sample temperature curves determined by experiment are depicted. Thus the major effects of the temperature variations are clear upon inspection. First, the liquid crystal (LC) curve shifts to lower voltage as the temperature of the LC rises. Second, the intensity of the achievable dark state rises as temperature rises. The apparent magnitude of the dark state intensity appears to increase nonlinearly as temperature rises. Third, the location of the peak of the voltage curves shifts to lower voltages as the temperature rises. Fourth, the height of the peak of the voltage curve drops slightly as temperature rises. Finally, the voltage required to achieve the best dark state (whatever that is) does not appear to move significantly with changes in temperature.

Thus from the above it is clear that the performance of a liquid crystal device is strongly temperature dependent. It is also clear that accurate measurements of the temperature of a liquid crystal device can enable several commonly known control mechanisms in the electro-optical-mechanical design of a product using such devices. Additionally, several unobvious designs can be implemented that can exploit by using an accurately measured temperature to achieve optimal performance from such devices under circumstances of widely varying temperature.

It is also noted that some liquid crystal modes are less susceptible than others to changes in performance attributable to temperature such as an example disclosed in the 1998 SID Conference Proceedings, by Kurogane, et al, “Reflective AMLCD for Projection Displays: D-ILA”, Paper 5.3. In FIG. 5 of that paper, the authors show that the voltage-transmission curve for the electro-optic mode under discussion changes little in the region of interest as a function of temperature. However, such devices would still require the use of a robust temperature sensor because there are device performance parameters such as switching speed still change significantly as the temperature varies even when operated in such electro-optic modes.

For these reasons, there is still need in the art of microdisplay such as the liquid crystal on silicon (LCOS) display to provide improved system architecture and methods of temperature measurements and control to improve the accuracy of temperature measurement in order to overcome the above-mentioned limitations and difficulties.

### SUMMARY OF THE PRESENT INVENTION

It is therefore an object of the present invention to provide new and improved circuit configurations by applying the proportional to absolute temperature (PTAT) type of temperature measurement to improve the accuracy of temperature measurements. Instead of measuring resistance variations across a distance of diode, a technique of temperature determination using frequency measurements is performed in this invention through a voltage control oscillator. The measurement circuits disclosed in this invention are more compatible with the use of a flexible PCA connection to the microdisplay to a board. The basic circuit of this invention achieved an improved resistance noise and provides additional operation modes with added benefits of more conveniently and flexibly determining an operation mode to overcome the measurement noises. Furthermore, measurement of frequency as carried out by this invention improves the measurement accuracy and reduces the likelihood of false temperature readings.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a diagram for showing the variations of the electro-optic performance of nematic liquid crystal versus the variations of temperature.

FIG. 2 is a functional block diagram of a temperature sensor implemented with dual diodes of this invention.

FIG. 2A is a circuit diagram for showing a resistor digital to analog converter (RDAC) for connecting directly to a voltage controlled oscillator in place of the temperature sensing diodes.

FIG. 3 is an alternate embodiment implemented with a single diode of FIG. 2.

FIG. 4A shows a microdisplay attached to a long extender flex (FPCA).

FIG. 4B shows a microdisplay with the long extender flex,

FIG. 4C shows a drive board for three microdisplays.

FIG. 4D shows a drive board with a microdisplay with an extender flex connected to one channel.

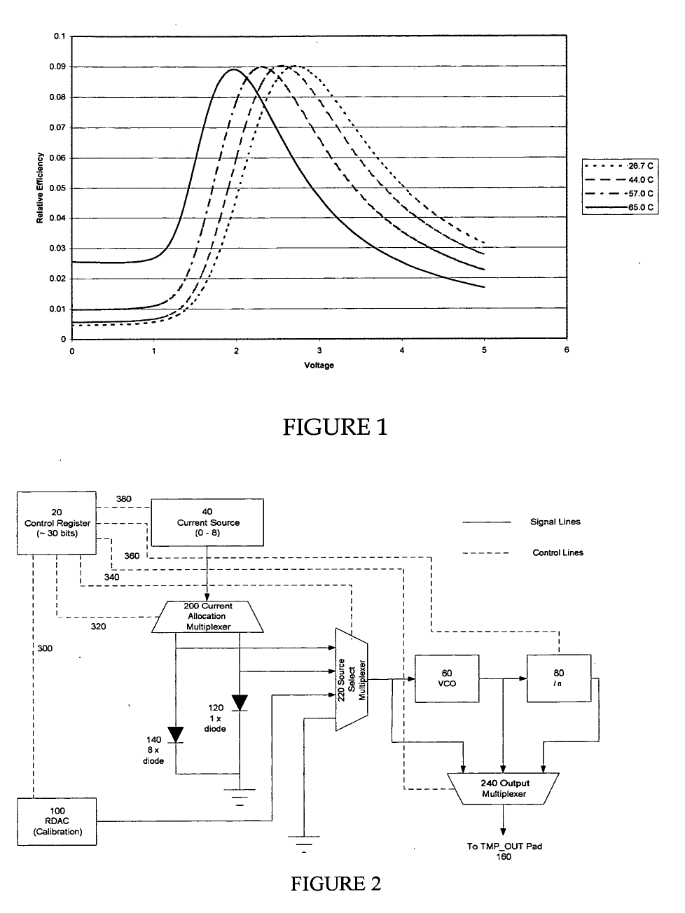

### DETAILED DESCRIPTION OF THE PREFERRED EMBODIMENT

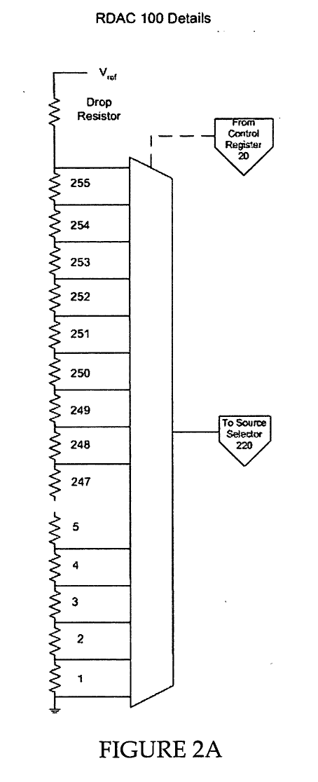

Referring to FIG. 2 for a functional diagram for showing the circuit configuration of a temperature sensor of this invention. The major components in the temperature circuit include two diodes 120 and 140 of eight-times area difference, e.g., show as 1× for diode 120 and 8× for diode 140. These two diodes thus have eight times difference in resistance when conducting the same amount of current. An adjustable current source 40 that is programmable and digitally controllable to have one to eight times of current are inputted to either one of the diodes 120 or 140 via a current allocation multiplexer 200. The output current from either of these diodes is inputted via a source select multiplexer 220 to a voltage controller oscillator 60 to generate a frequency corresponding to the input current and the output from the VCO 60 is inputted to an n-divider 80. An output for connecting to a TEMP_OUT pad 160 is selected between the raw output from the source selecting multiplex 220, the VCO 60 and the n-divider 80 to provide data for temperature analyses.

Collectively, these allow the operating temperature of the microdisplay to be determined based on the following equations of currents flowing through the diodes 120 and 140 and applying these currents in temperature measurement analyses. The voltage across a diode can be generally defined as:
v_{diode}=n*kt/q*ln(I_{Diode}/IS) (1)
For two different currents conducted through diodes 120 and 140, I_{Diode0}, and I_{diode1}, respectfully, the voltages across these two diodes are:
v_{diode1}=n*kt/q*ln (I_{Diode1}/IS) (2)
v_{diode1}−V_{diode0}=n*kt/q*ln(I_{Diode1}/I_{diode0}) (3)
In practice, this works out to about 60-90 mv for every factor of 10 that I_{Diode1} is larger than I_{Diode0}
(kt/q is ˜26 mv at room temperature, and ln (10) is ˜2.3). ‘n’ is generally between 1 and 1.7)
k=Boltzmann's constant
t=temoerature in degrees Kelvin
q=charge proportional to coulombs
   With these two diodes 120 and 140 having eight times difference in areas thus having eight times difference of diode resistance, and the adjustable current source 40 provided to provide a current input with an 8:1 range, collectively, these allow a I_{Diode1}/I_{Diode0} ratio from 1 to 64.

The temperature sensor when implemented with two diodes as that shown in FIG. 2 has a special characteristic that through the use of the current allocation multiplexer 200, the measurement can use either of the diodes with a surface area ratio of 8 to 1. Therefore when the same current source is applied to one and then to the other, there is a current density ratio of 8 to 1 between the two measurements. Under the circumstances when two or more current sources are implemented, with adjustable input current applied to the same diode, the temperature sensing operation as shown provides flexibility of eight to one current density between the voltage measured one way compared to a different voltage measured by applying a different current source.

The circuit configuration as shown in FIG. 2 allows for more flexible and accurate measurement of the voltage of the diodes. A programmable input digital to analogy converter DAC voltage (on die) is first inputted from a resistor digital to analog converter (RDAC) 100 into the VCO 60 to measure the VCO frequency. Then the voltage across either of the diodes is selected for inputting to the VCO 60 and its frequency re-measured. The ratio of the frequencies represents the ratio of voltages. This process can be iterated by selecting different DAC input voltages to produce a measurement for each diode operating at different range of voltages for a given programmed current. This flexibility in the selection of source, device and output improves the ability to cross-calibrate and also enables the system to use the CMOS diodes in the region in which they most reliably function as the temperature sensing diodes.

Referring to FIG. 2A for a circuit diagram of a resistor digital to analog converter (RDAC) 100 as implemented in the present invention and its application as that shown in FIG. 2. A digital to analog converter, i.e., DAC, converts a digital signal to a corresponding analog voltage. They can be implemented either as a resistor network where the drop of voltage across a chain of resistor provides a very linear relationship between the digital word and the corresponding voltage or as a current DAC. Both are well known to those experienced in the art of circuit design. For this invention, an RDAC is implemented because of the highly linear relationship that can be achieved between the digital word and the RDAC output voltage. When an RDAC is implemented in CMOS, the consistency of the resistor network is inherently very high and therefore the RDAC circuit 100 also provides output with a high linearity. This means that not only is the output of the RDAC monotonic but also that the voltage increments between individual steps is highly consistent. Because of these characteristics, an RDAC implemented in CMOS is a good choice to function as a calibration source when measuring other voltages on the same die. In the present invention the output of the temperature sensor is fed into a VCO creates a frequency that corresponds to the voltage. Without calibration it is difficult to know a priori what voltage the measured frequency represents.

This invention therefore discloses a method for measuring a temperature of a display system. The method includes a first step of applying a voltage, i.e., Vtemp, of a temperature sensing diode to the VCO to generate a temperature corresponding output frequency, i.e., Freq (temp), from the VCO. A second step is to apply an independent adjustable voltage source on a voltage controlled oscillator to determine a functional correlation, i.e., Freq=F (Vin), between a frequency of the VCO, i.e., Freq, and an input voltage, i.e., Vin, to the VCO. A third step is using the frequency-voltage functional correlation generated by the first step to determine the temperature sensing voltage across the temperature sensing diode, i.e., Vtemp, from the output frequency, i.e., Freq(temp), of the VCO. And then a final step is to determine the temperature from the temperature sensing voltage across the temperature sensing diode, i.e., Vtemp, by using equations (1). Furthermore, by using Equation (1) to equation (3), the accuracy of such measurements can be accurately calibrated by using different diodes, e.g., diodes 120 and 140, by applying different input currents through the adjustable current source 40 in a stepwise and iterative manner.

It would be possible to feed the temperature sensor voltage directly into an analog to digital converter circuit to facilitate a direct reading of the voltage, but there are problems in the implementation of such circuits in CMOS. The principle one is that A-to-D circuits implemented in CMOS often suffer from reduced accuracy. By feeding the voltage into the VCO and then by subsequently feeding the output of the highly stable reference RDAC into the same VCO, the problems of measurement accuracy and calibration can be largely solved. The following descriptions further explain how the calibrations are carried out. First the output of the VCO when driven by the voltage output of the temperature sensor is not likely to be exactly equal to one of the steps on the RDAC so any assessment of a given condition will likely yield two voltage values that create frequencies that bound the frequency created by the output of the temperature. In the simplest case the three frequencies can be considered to relate linearly to three voltages. Since two of the voltages are known, the third can be estimated by linear interpolation. An example of the calculation follows.

Let V_DACₓ and V_DACₓ₊₁ correspond to frequencies fₓ and fₓ₊₁. Let f_{y} correspond to the frequency measured by unmeasured voltage V_TMP_{y}. By assumption fₓ<f_{y}<fₓ₊₁ and by assumption V_DACₓ<V_TMP_{y}<V_DACₓ₊₁. Further assuming that the relationship is linear, then the mathematical relationship should apply.
V_{—}TMP_{y}=V_{—}DACₓ+(((f_{y}−fₓ)/(fₓ₊₁−fₓ))*(V_{—}DACₓ₊₁−V_{—}DACₓ))
The foregoing requires some assumptions and imposes some constraints on the silicon design. The output of the VCO as a function of voltage can be made to be monotonic although it is probably not completely linear in all regions of interest. It would be possible to develop a mathematical function to approximate the output of the VCO as a function of voltage in an area of interest without difficult, or even a linear approximation is probably sufficient in most instances. The benefit of using interpolation is that affords the opportunity to improve the temperature accuracy and resolution while using a relatively simple RDAC configuration

The circuit configuration shown in FIG. 2 allows for multiple levels of selections and flexibility, selectable through a 30-bit control register 20. The control register 20 communicates through control data to the various components through control lines as shown in dashed lines. Control line 300 links control register 20 to RDAC 100. Control line 320 links control register 20 to current allocation multiplexer 200. Control line 340 links control register 20 to source select multiplexer 220. Control line 360 links control register 20 to output multiplexer 240. Control line 380 links control register 20 to “Divide by n” servo 80.

The control register 20 thus can exercise a first selection in the choice of current source level in current source 40. The level of current source may range from 1× to 8×. The second selection is in the choice of diode—1× (120) or 8× (140). This selection is made through current allocation multiplexer 200. One consequence of these choices of values is that a first level of cross-calibration exists between the two diodes—a 1× current fed into the 8× diode 140 is equivalent to an 8× current fed into the 1× diode 120. The source select multiplexer 220 selects the output of the same diode selected by the current allocation multiplexer or alternatively selects the output of the RDAC 100 to be passed through the system. Finally the output multiplexer 240 selects between the raw output of the devices, the output of the VCO 60, or the output of the VCO passed through the “/n” (divide by n) stage 80. In the first implementation the output of the current source is taken off the microdisplay through the TMP_OUT pad 160 on the die. In alternative embodiments it would be possible to develop a microdisplay silicon design that permits the microdisplay silicon to calculate the device temperature and deliver this in digital form through the wire bond pads.

The “divide by n” stage carried out by the n-divider 80 is particularly useful where “n” is an integer loaded into the device from the control register 20 to permit the output square wave frequency to be selectable. This enables the device controller to avoid frequencies where the on-chip interference level is high due to the digital drive mechanisms. Because these frequencies vary with the specifics of the application, such flexibility is needed assure that the signal is usable. Additionally, by being able to select lower intervals, it is possible to switch from frequency measurement to time domain measurement as the means of measuring the signal.

The microdisplay controller system or a microprocessor performs a sequential sampling of the output of pad 160. The sampled data is reduced to a temperature value by a processor and that information is then available for use by that or other components in the system for servo control or other uses. The projection system controller may use the information as part of its feedback system for control of various ventilation or other thermal control systems. These thermal control systems may include such devices as case fans, fans mounted so as to ventilate the heat dissipation means for the microdisplay, or devices such as Peltier heater/coolers. It may also be used by the microdisplay control system to modify the method of control of the liquid crystal drive voltages or the like. Many variations on this can readily be conceived. They are within the scope of the invention.

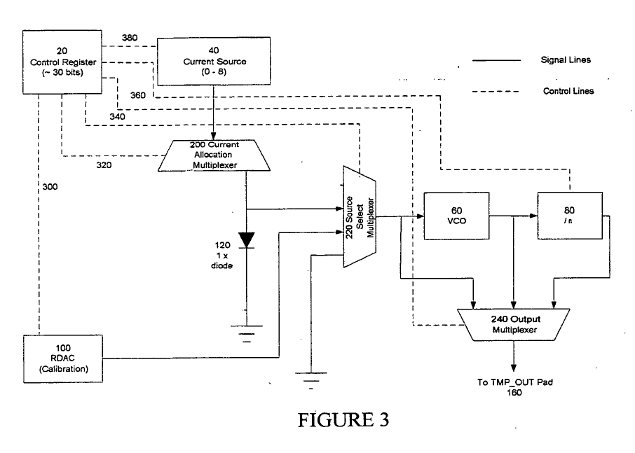

FIG. 3 is a circuit diagram showing a temperature sensor of this invention implemented with only one diode and at least two current sources. The operational principles and measurement techniques are similar to that described for FIG. 2.

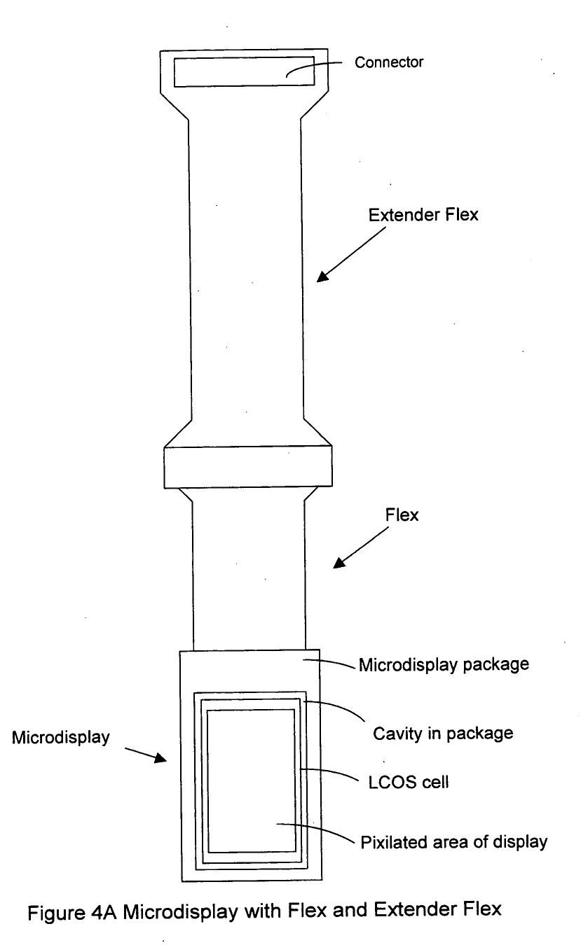

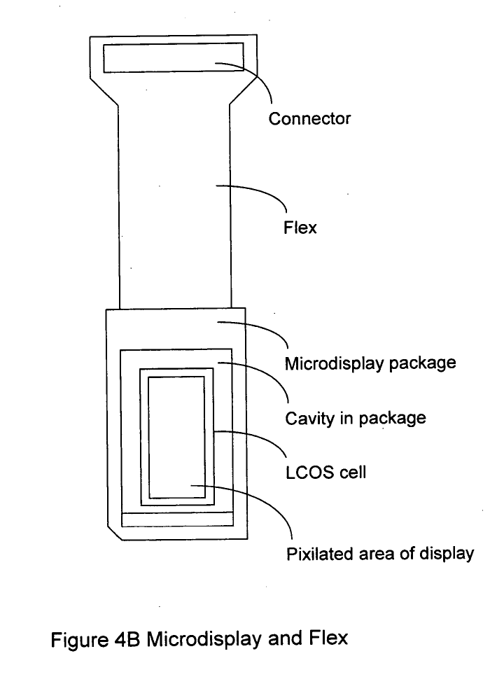

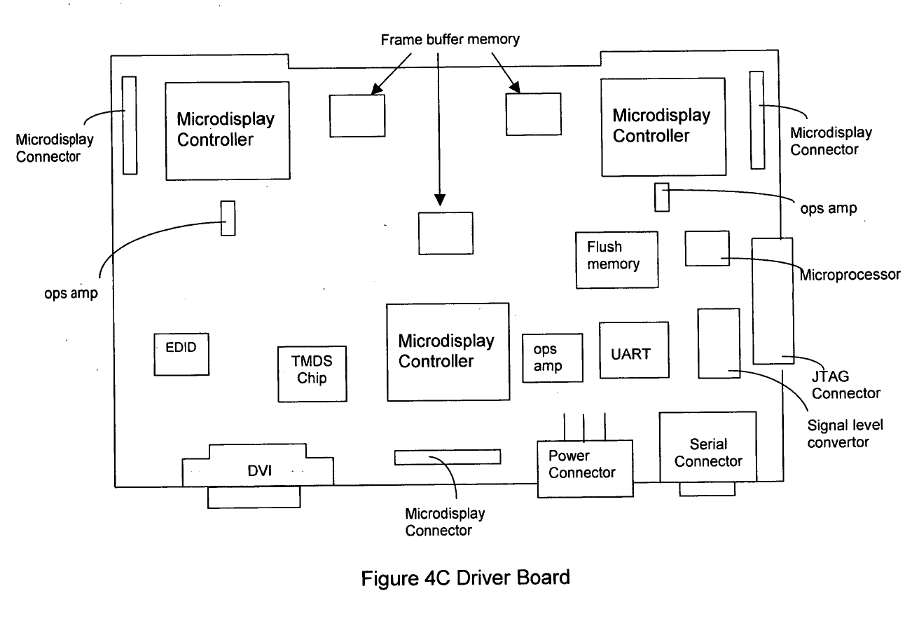

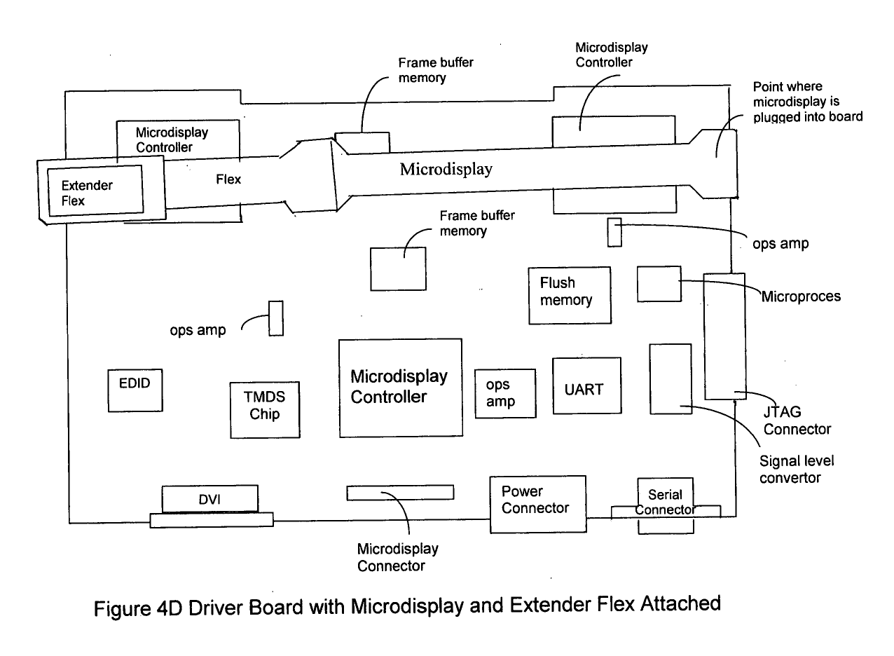

FIG. 4A is shows a microdisplay attached to a long extender flex (FPCA). FIG. 4B shows a microdisplay with the long extender flex, FIG. 4C shows a drive board for three microdisplays, FIG. 4D shows a drive board with a microdisplay with an extender flex connected to one channel. The point of connection is in the upper right corner. The drive board would normally be mounted above or below the optical engine so the flex can bend by 90 degrees and the microdisplay face is facing to the of the board where the figure shows a view of the at the back of the microdisplay. The temperature sensor is fabricated into the silicon backplane of the microdisplay. The flex—in this case the short flex is approximately 4 cm while the extender adds another 15 cm—connects the signals from the drive board to the microdisplay and also connects data from the microdisplay over the flex to the drive board. As shown in FIGS. 5C and 5D, the implementation includes three controller chips and these chips can read the data from the microdisplay and correlate it to a temperature.

In this invention the temperature sensors are integrated into the backplane of a microdisplay. The temperature sensor includes at least one diode. The sensor system can be implemented either with one or more than one current source when only one diode is implemented and the temperature sensor system uses at least one current source when two or more diodes are used. In a preferred embodiment, the temperature sensor system includes more than one diode and more than one current sources because by providing least two differing outputs for the same temperature setting, the temperature sensing system enables an operation to cross-check the accuracy of temperature measurement during a calibration operation. The voltage output from the diode is implemented as an input voltage to a voltage controlled oscillator thus generating an input voltage dependent frequency thus simplified the temperature measurement. With multiple level of input adjustment and output measurements, the processes allow for using the diode output to assess against the calibration data thus to calibrate the temperature system to react accurately to the temperature variations.

According to above figures and descriptions, this invention discloses a display system that includes a temperature sensing circuit. The temperature sensing circuit includes a current source connected to a temperature sensing diode for providing an input to a voltage controlled oscillator (VCO) for generating a frequency output corresponding to the input voltage as a function of a temperature measurement by the temperature sensing diode. In a preferred embodiment, the display system further includes a resistor digital-to-analog converter (RDAC) for digitally controlling a voltage inputted to the VCO in place of the temperature sensing diode. In a preferred embodiment, the temperature sensing circuit is disposed on a backplane of the display system. In a preferred embodiment, this invention discloses a display system that includes a temperature sensing circuit disposed on a backplane wherein the temperature sensing circuit includes at leas two diodes for measuring a same local temperature on the backplane.

In essence, this invention discloses a display system that includes a temperature sensing means that includes a means for generating an output frequency corresponding to a temperature measurement. In a preferred embodiment, the temperature sensing means further includes voltage-controlled oscillator (VCO) for generating the output frequency. In a preferred embodiment, the temperature sensing means further includes a diode for passing a current for providing an input voltage to the VCO for generating the output frequency corresponding the temperature measurement. In a preferred embodiment, the temperature sensing circuit further includes at least two diodes of different sizes. In a preferred embodiment, the temperature sensing means further includes at least two current sources for providing two different currents. In a preferred embodiment, the display system further includes a resistor digital-to-analog converter (RDAC) for digitally controlling a voltage inputted to the VCO. In a preferred embodiment, the display system further includes a dividing-by-n (/n) circuit for modifying a frequency output from the VCO. In a preferred embodiment, the display system further includes a dividing-by-n (/n) circuit for modifying a frequency output from the VCO with a selectable value of n. In a preferred embodiment, the display system further includes a multiplexing circuit controlled by a controller for controlling a configuration of the temperature sensing means. In a preferred embodiment, the temperature sensing means further includes at least two diodes of different sizes having the multiplexing circuit connected thereto whereby the controller controlling the configuration by selecting either-or-both of the diodes. In a preferred embodiment, the temperature sensing means further includes at least two current sources for providing two different currents having the multiplexing circuit connected thereto whereby the controller controlling the configuration by selecting either-or-both of the current sources. In a preferred embodiment, the display system further includes a resistor digital-to-analog converter (RDAC) for digitally controlling a voltage inputted to the VCO having the multiplexing circuit connected thereto whereby the controller controlling the configuration by selecting an input from the RDAC to the VCO. In a preferred embodiment, the display system further includes a dividing-by-n (/n) circuit for modifying a frequency output from the VCO with a selectable value of n having the multiplexing circuit connected thereto whereby the controller controlling the configuration by selecting a value of the n.

A method for measuring a temperature in a display system is disclosed in this invention. The method includes a step of disposing a temperature sensing circuit on a backplane for generating a frequency output corresponding to a temperature measurement. In a preferred embodiment, the step of disposing the temperature sensing circuit on the backplane further includes a step of disposing a diode temperature sensing means on the backplane. In a preferred embodiment, the step of disposing the temperature sensing circuit on the backplane further includes a step of disposing two diode temperature sensing means on the backplane. In a preferred embodiment, the step of disposing temperature-sensing circuit further includes a step of disposing on the backplane a current source and a means for converting a measured current by the temperature sensing circuit to the frequency corresponding to the temperature measurement. In a preferred embodiment, the step of disposing the temperature sensing circuit on the backplane further includes a step of disposing on the backplane a current source and a voltage control oscillator (VCO) for converting a measured current by the temperature sensing circuit to the frequency corresponding to the temperature measurement. In a preferred embodiment, the step of disposing the temperature sensing circuit on the backplane further includes a step of disposing the temperature sensing circuit on a backplane of a liquid crystal microdisplay system.

In essence, this invention discloses a method for measuring a temperature in a display system that includes a step of applying an independent adjustable voltage source on a voltage controlled oscillator (VCO) to determine a functional correlation between a frequency of the VCO and an input voltage to the VCO. In a preferred embodiment, the method further includes a step of applying a temperature sensing voltage from a temperature sensing diode to the VCO to generate a temperature corresponding output frequency from the VCO. In a preferred embodiment, the method further includes a step of using the frequency-voltage functional correlation and the output frequency of the VCO to determine the temperature sensing voltage across the temperature sensing diode. In a preferred embodiment, the method further includes a step of determining a temperature measurement from the temperature sensing voltage across the temperature sensing diode.

The temperature sensing measurement for the display system as disclosed in this invention can achieve improved resistance to noise measurements from several controllable operational modes of the system and not just one feature in the circuit. The system of this invention enables the choices of frequencies where there is less noise and therefore more ability to discern the signal. Also, the measurement of a frequency is inherently easier than the measurement of a resistance over a long wire that may have several kinks and bends in it. The additional modes of measurements as provided according to the preferred embodiments show above are simply illustrated for better understanding that the use of a dividing-by-/n circuit to change the frequency over the wire to one that is relatively noise free. The development of the dividing by n/circuit involves the choice of operating clock speed and data rate over the FPCA that can be dynamically changing thus requiring the use of dynamic driving algorithm to achieve the results of reduced noises with improved image quality. In addition to the improvement of measuring frequency instead of resistance for temperature sensing, the flexibility to adjust the frequency ranges for reducing the signal to noise ratio is essential to further improve the temperature measurement accuracy.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A display system comprising:
a temperature sensing circuit comprising a current source connected to a temperature sensing diode for providing an input to a voltage controlled oscillator (VCO) for generating a frequency output corresponding to said input voltage as a function of a temperature measurement by said temperature sensing diode.

2. The display system of claim 1 further comprising:
a resistor digital-to-analog converter (RDAC) for digitally controlling a voltage inputted to said VCO in place of the temperature sensing diode.

3. The display system of claim 1 wherein:
said temperature sensing circuit is disposed on a backplane of said display system.

4. A display system comprising:
a temperature sensing means including a means for generating an output frequency corresponding to a temperature measurement.

5. The display system of claim 4 wherein:
said temperature sensing means further comprising voltage controlled oscillator (VCO) for generating said output frequency.

6. The display system of claim 5 wherein:
said temperature sensing means further comprising a diode for passing a current for providing an input voltage to said VCO for generating said output frequency corresponding said temperature measurement.

7. The display system of claim 4 wherein:
said temperature sensing circuit further comprising at least two diodes of different sizes.

8. The display system of claim 4 wherein:
said temperature sensing means further comprising at least two current sources for providing two different currents.

9. The display system of claim 4 further comprising:
a resistor digital-to-analog converter (RDAC) for digitally controlling a voltage inputted to said VCO.

10. The display system of claim 4 further comprising:
a dividing-by-n (/n) circuit for modifying a frequency output from said VCO.

11. The display system of claim 4 further comprising:
a dividing-by-n (/n) circuit for modifying a frequency output from said VCO with a selectable value of n.

12. The display system of claim 4 further comprising:
a multiplexing circuit controlled by a controller for controlling a configuration of said temperature sensing means.

13. The display system of claim 12 wherein:
said temperature sensing means further comprising at least two diodes of different sizes having said multiplexing circuit connected thereto whereby said controller controlling said configuration by selecting either-or-both of said diodes.

14. The display system of claim 12 wherein:
said temperature sensing means further comprising at least two current sources for providing two different currents having said multiplexing circuit connected thereto whereby said controller controlling said configuration by selecting either-or-both of said current sources.

15. The display system of claim 12 further comprising:
a resistor digital-to-analog converter (RDAC) for digitally controlling a voltage inputted to said VCO having said multiplexing circuit connected thereto whereby said controller controlling said configuration by selecting an input from said RDAC to said VCO.

16. The display system of claim 12 further comprising:
a dividing-by-n (/n) circuit for modifying a frequency output from said VCO with a selectable value of n having said multiplexing circuit connected thereto whereby said controller controlling said configuration by selecting a value of said n.

17. A method for measuring a temperature in a display system comprising:
disposing a temperature sensing circuit on a backplane for generating a frequency output corresponding to a temperature measurement.

18. The method of claim 17 wherein:
said step of disposing said temperature sensing circuit on said backplane further comprising a step of disposing a diode temperature sensing means on said backplane.

19. The method of claim 17 wherein:
said step of disposing said temperature sensing circuit on said backplane further comprising a step of disposing two diode temperature sensing means on said backplane.

20. The method of claim 17 wherein:
said step of disposing temperature sensing circuit further comprising a step of disposing on said backplane a current source and a means for converting a measured current by said temperature sensing circuit to said frequency corresponding to said temperature measurement.

21. The method of claim 17 wherein:
said step of disposing said temperature sensing circuit on said backplane further comprising a step of disposing on said backplane a current source and a voltage control oscillator (VCO) for converting a measured current by said temperature sensing circuit to said frequency corresponding to said temperature measurement.

22. The method of claim 17 wherein:
said step of disposing said temperature sensing circuit on said backplane further comprising a step of disposing said temperature sensing circuit on a backplane of a liquid crystal microdisplay system.

23. A method for measuring a temperature in a display system comprising:
applying an independent adjustable voltage source on a voltage controlled oscillator (VCO) to determine a functional correlation between a frequency of the VCO and an input voltage to the VCO.

24. The method of claim 23 further comprising:
applying a temperature sensing voltage from a temperature sensing diode to said VCO to generate a temperature corresponding output frequency from the VCO.

25. The method of claim 24 further comprising:
using said frequency-voltage functional correlation and said output frequency of said VCO to determine said temperature sensing voltage across the temperature sensing diode.

26. The method of claim 25 further comprising:
determining a temperature measurement from said temperature sensing voltage across said temperature sensing diode.

27. A display system comprising:
a temperature sensing circuit disposed on a backplane wherein said temperature sensing circuit comprising at leas two diodes for measuring a same local temperature on said backplane.
